(19) United States
(12) Patent Application Publication
(10) Pub. No.: US 2004/0109980 A1
(43) Pub. Date: Jun. 10, 2004

(54) Grip tape with self-textured surface

(76) Inventors: Sam H. Chen, San Diego, CA (US); C. F. Chang, Taichung (TW)

Correspondence Address: Calif Tervo, 6387 Caminito Lazaro, San Diego, CA, 92111, US

(21) Appl. No.: 10/316,216

(22) Filed: Dec. 10, 2002

(51) Int. Cl. B32B 3/10

(52) U.S. Cl. 428/131; 428/174; 428/156

(57) ABSTRACT

Grip tape for wrapping a handle to improve the grip is formed by perforating a cushioning layer, such as of felt, and applying an elastomeric coating. The elastomer fills the perforations and coats the upper surface of cushioning layer. Because of surface tension, elastomer cures to form a dimple above each perforation. Dimples create texture on the gripping surface that improve the grip.

### FIELD OF THE INVENTION

This invention relates to grip tape for wrapping a handle, and more particularly to grip tape for wrapping the handle of a sport device, such as a golf club or tennis racquet.

### BACKGROUND OF THE INVENTION

Grip tape for wrapping a sport racquet or club handle to enhance grip and to reduce shock is well-known. Grip tapes have been made of leather, rubber, and plastic. One type of conventional grip tape comprises a layer of polyurethane backed with a layer of felt. The felt layer is generally thicker than the polyurethane layer and provides part of the elasticity, strength, cushioning, and shock resistance. The polyurethane layer provides a tacky gripping surface and part of the cushioning and shock resistance.

Typically, the polyurethane is applied to the felt by coagulation coating. This well-known type of cushioning is resilient, slightly stretchy, tacky, and provides a good grip for a hand. The felt reinforces the rubbery polyurethane to keep it from tearing and the polyurethane keeps the felt from fraying and provides a degree of water resistance. The cushioning material is then slit into an elongate tape generally in the range of 1 to 3 centimeters that can be wrapped onto a handle, often combined with a layer of double-sided adhesive tape to attach the grip tape to the handle.

To improve the grip and appearance, a design is sometimes embossed into the upper face of the cushion with heat and pressure.

A problem with embossed grip tapes of this type is that the embossed portions are compressed and thus harder than the uncompressed portions. The outer surface of the embossed portions is also smoother. The combination of smoothness and hardness causes the embossed portions to be less tacky.

It is well-known that surface texture can improve the grippability of a handle, but a poorly-designed embossing pattern may not yield a net improvement in grip and even a well-designed pattern does not provide an optimal grip because of the smoothing and hardening of the surface.

Another technique that has been widely used to provide texture and grippability to the handle is perforation of the grip tape. Typically, a perforated grip tape includes a perforated upper layer of vinyl or polyurethane “artificial leather” and an unperforated lower layer of foam rubber or felt. Perforations in the grip tape cause the grip to soak up moisture, such as from rain or spilled beverages. The perforations also collect dirt. This technique of perforation was developed to use with materials that are not intrinsically very “tacky.” If the outer gripping surface of a grip tape is composed of a “tacky” material, decreasing the surface area of the outer surface by cutting holes in it does not increase the grippability of the handle. A third disadvantage of a perforated surface is that the perforations tend to snag sharp objects and be torn by them.

There is thus a need for a grip tape that includes surface texture but does not require embossing or other process that decreases the gripping quality of the surface. There is a need for a grip tape that includes a grippable surface texture that is readily manufactured using standard equipment and methods. There is a need for a grip tape with a grippable, durable surface texture that is manufactured from standard materials. There is a need for a grip tape that does not absorb and retain moisture or liquid, and that is easily washed.

### SUMMARY OF THE INVENTION

The present invention is a grip tape for wrapping a handle, such as of a tennis racquet or golf club. The grip tape is wrapped helically onto the portion of the handle that is gripped by a hand, as is well-known. The grip tape provides cushioning of impacts to protect the elbow and wrist of the user and improves the user's grip upon the handle.

The present grip tape is a modification of the conventional grip tapes formed by coating a strip of felt with porous polyurethane rubber.

The felt strip is perforated before coating. The perforations are typically I to 3 millimeters across and pass through the felt strip from one face to the other. The perforations may be arranged in a regular grid or in any preferred pattern.

The perforated felt strip is then coated with a resilient elastomer from a liquid solution or emulsion, such as polyurethane. The liquid elastomer fills the perforations and coats at least one surface of the felt. The elastomer forms a planar coating above the non-perforated portion of the felt. Because of “surface tension”, the elastomer has a non-planar surface above each perforation. In a preferred embodiment wherein felt perforated with holes is coagulation-coated with polyurethane dissolved in di-methyl formamide, the surface of the polyurethane includes a concave dimple over each hole.

The present grip tape includes a dimpled texture that provides a good grip without an embossing operation. The outer surface of the grip tape is uniformly soft and resilient. The present grip tape is manufactured inexpensively because the perforation process does not employ heated rollers, as embossing does.

The invention will now be described in more particular detail with respect to the accompanying drawings in which like reference numerals refer to like parts throughout.

### BRIEF DESCRIPTION OF THE DRAWINGS

FIG. 1 is a side view, partially cut away, of the grip tape wrapped upon a handle of a golf club.

FIG. 2 is a top view, partly cut away, of the grip tape material before slitting.

FIG. 3 is a sectional view of the grip tape material of FIG. 2, taken along line 3-3 of FIG. 2.

### DETAILED DESCRIPTION OF THE INVENTION

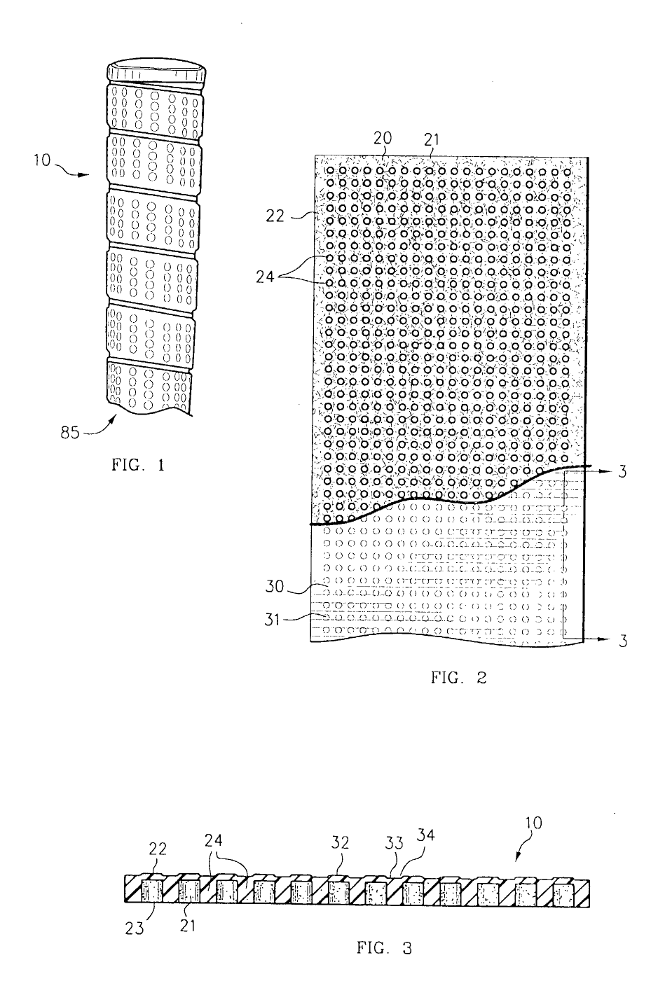

FIG. 1 is a side view, partially cut away, of the grip tape 10 wrapped upon a handle 80 of a golf club. FIG. 2 is a top view, partly cut away, of the grip tape material before it is slit to the required width.

The grip tape material may be made in any width that is practical. The material is slit to the desired width for wrapping on handle 85, typically in the range of 10 to 35 millimeters. Grip tape 10 is wrapped helically upon handle 85. Grip tape 10 is slightly stretchy and clings to handle 85 if grip tape 10 is stretched as it is wrapped. Alternatively, adhesive such as double-sided adhesive tape may be used to attach grip tape 10 securely to handle 85.

Grip tape 10 provides a more secure grip on handle 85 and cushions the hands and arms from the shock of hitting a ball. Grip tape 10 generally includes a base layer 20, such as felt 21. Other suitable materials include other textile materials, leather, or a synthetic material with shock damping properties, such as sponge rubber.

Felt layer 21 is pierced by small perforations 24 closely spaced, such as in a grid or other desirable pattern. Perforations 24 illustrated in the drawings are squares 1 millimeter in width and are on 2.5 millimeter centers. The perforations may be round, square, or other convenient shape. Preferably, perforations 24 are small enough that the elongation and tensile strength of grip tape 10 are uniform along the width and length of grip tape 10. Perforations 24 extend from upper face 22 to lower face 23 of felt layer 21.

Perforations 24 may be die-cut or punched in the case of base layer 20 being of felt 21 or leather, or may be an integral part of base layer 20 in the case of other textile or synthetic materials.

Perforated felt layer 21 is coated with an elastomer, such as silicone rubber, latex, or porous polyurethane 31 deposited by coagulation coating, as is well-known. The elastomer should be soft and comfortable to the hand, as well as provide a secure grip. Such an elastomer is often called “tacky,” meaning it has high friction with human skin, although the elastomer does not actually adhere to the hand or transfer material to it.

The elastomer is applied in liquid form, such as from a solution or emulsion, and is preferably applied to upper face 22.

Polyurethane 31 fills perforations 24 and coats upper face 22. Polyurethane 31 covers the non-perforated areas of felt 21 with a planar portion 32. Because of surface tension, polyurethane 31 typically forms a non-planar portion 33 over each perforation 24. Non-planar portion 33 is typically a concave meniscus, or dimple, 34. In the case of combinations of materials other than felt 21 and polyurethane 31, non-planar portion 33 may be a convex meniscus, or bump.

In an alternative embodiment, not illustrated, perforations 24 do not completely pierce base layer 20. Each perforation 24 is instead deeply indented into upper face 22 but does not extend to lower face 23. Each such non-piercing perforation 24 must be deep enough that polyurethane 31 forms a dimple 34 over each non-piercing perforation. Herein, including in the claims, “perforation” should be read as including deep indentations that do not completely pierce base layer 20.

I claim:

1. An elongate grip tape for wrapping a handle including:
a cushioning layer; including
a top face;
a bottom face;
a plurality of perforations between said top face and said bottom face; and
an outer skin for contact with a hand attached to said top face of said cushioning layer; including:
a planar portion overlying said top face; and
a plurality of non-planar areas, each said non-planar area overlying one said perforation.

2. The grip tape of claim 1, said cushioning layer comprising a layer of textile felt.

3. The grip tape of claim 2, said outer skin comprising an elastomer

4. The grip tape of claim 3, said elastomer comprising porous polyurethane.

5. The grip tape of claim 1, said non-planar areas comprising dimples indented below said planar portion.

6. The grip tape of claim 1, said cushioning layer having a thickness in the range of 0.9 to 2.1 millimeters.

7. The grip tape of claim 1, said non-planar areas comprising bumps rising above said planar portion.

8. A method for making a grip tape for wrapping a handle, including the steps of
forming a plurality of perforations in a cushioning layer;
coating the cushioning layer with a liquid that can be cured to form an elastomer; such that the liquid fills the plurality of perforations such that the cured elastomer forms a non-planar area above each perforation.

9. The method of claim 8, wherein the plurality of perforations pierce the cushioning layer from top to bottom.

10. The method of claim 8, wherein the plurality of perforations are deeply indented into the top of the cushioning layer but do not pierce through to the bottom.

11. The method of claim 9, wherein the step of forming a plurality of perforations comprises die-cutting the cushioning layer.

12. The method of claim 8, wherein the step of coating the cushioning layer with a liquid that can be cured to form an elastomer includes the step of coagulation coating with polyurethane emulsion.

13. The method of claim 8, wherein the non-planar area above each perforation is a concave dimple.

14. The method of claim 8, wherein the non-planar area above each perforation is a convex bump.
